(19) United States
(12) Patent Application Publication
(10) Pub. No.: US 2024/0134053 A1
(43) Pub. Date: Apr. 25, 2024

(54) TIME-OF-FLIGHT DATA GENERATION CIRCUITRY AND TIME-OF-FLIGHT DATA GENERATION METHOD

(71) Applicant: Sony Semiconductor Solutions Corporation, Atsugi-shi, Kanagawa (JP)

(72) Inventors: Stefan ISLER, Stuttgart (DE); Valerio CAMBARERI, Stuttgart (DE)

(73) Assignee: Sony Semiconductor Solutions Corporation, Atsugi-shi, Kanagawa (JP)

(21) Appl. No.: 18/278,178

(22) PCT Filed: Feb. 25, 2022
(86) PCT No.: PCT/EP2022/054738

§ 371 Date: Aug. 21, 2023

(30) Foreign Application Priority Data
Mar. 3, 2021 (EP) 21160428.5

(51) Int. Cl. G01S 17/894; G01S 7/4861; G01S 7/4865; G01S 17/66

(52) U.S. Cl. CPC G01S 17/894; G01S 7/4861; G01S 7/4865; G01S 17/66

(57) ABSTRACT

The present disclosure generally pertains to time-of-flight data generation circuitry, configured to: acquire a time-of-flight (ToF) data stream using a ToF camera; acquire a brightness change event data stream using an event-based vision sensor (EVS), camera; correlate the time-of-flight data stream with the brightness change event data stream in time with each other for generating at least one time-of-flight data frame; and generate the at least one time-of-flight data frame based on the correlation.

### TECHNICAL FIELD

The present disclosure generally pertains to time-of-flight data generation circuitry and a time-of-flight data generation method.

### TECHNICAL BACKGROUND

Generally, time-of-flight (ToF) cameras are known. Such cameras may measure a depth of a scene (e.g., an object) by illuminating the scene with modulated light (at infrared wavelength, for example).

ToF cameras may generally be distinguished between indirect ToF (iToF) and direct ToF (dToF).

In iToF, the scene may be illuminated with modulated light and a depth sensing may be based on measuring a phase delay of a continuous return waveform, such that a depth map (or a point cloud) can be generated.

In dToF, the scene may be illuminated with pulsed light and a time delay of the pulsed return waveform may be measured by processing histograms of photon counts for generating a depth map (or a point cloud).

Such depth sensing technologies are nowadays used in various markets, such as automotive (in-cabin and forward-facing) or mobile phones (backwards or forwards-facing).

Furthermore event-based vision sensors (EVS) or dynamic vision sensor (DVS) are generally known. Such sensor may be configured as imaging sensors which output a high-speed asynchronous stream of events, i.e., brightness changes in the scene. The changes may be indicated with absolute values (without a polarity) or may be indicative of a polarity of the brightness change, i.e., whether the brightness increases (positives polarity) or decreases (negative polarity). Furthermore, brightness changes may be identified based on a time stamp and a pixel coordinate and the brightness change events may occur independently and asynchronously across the event-based image frame, such that events may be detected at a high speed and such that an EVS/DVS may be used in a context of scene-motion or ego motion.

It is further known that, based on events, it is possible to reconstruct grayscale images at high rates and high dynamic ranges. Furthermore, it is known that event data can be fused with color images. Furthermore, it is known that event data can be used in a simultaneous localization and mapping (SLAM) system.

Although there exist techniques for generating ToF data, it is generally desirable to provide a ToF data generation circuitry and a ToF data generation method.

### SUMMARY

According to a first aspect, the disclosure provides time-of-flight data generation circuitry, configured to:
acquire a time-of-flight data stream;
acquire a brightness change event data stream;
correlate the time-of-flight data stream with the brightness change event data stream in time with each other for generating at least one time-of-flight data frame; and
generate the at least one time-of-flight data frame.

According to a second aspect, the disclosure provides a time-of-flight data generation method, comprising:
acquiring a time-of-flight data stream;
acquiring a brightness change event data stream;
correlating the time-of-flight data stream with the brightness change event data stream in time with each other for generating at least one time-of-flight data frame; and
generating the at least one time-of-flight data frame.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically depicts time-of-flight data generation circuitry according to the present disclosure;

FIG. 2 depicts a time-of-flight data generation method for intra-frame motion compensation according to the present disclosure;

FIG. 3 depicts a further embodiment of a time-of-flight data generation method for inter-frame motion compensation according to the present disclosure;

FIGS. 4a and 4b depict a further embodiment of a time-of-flight data generation method for obtaining temporal super-resolution (i.e., high or asynchronous frame-rate interpolation) according to the present disclosure;

FIG. 5 depicts different embodiments of ToF data generation circuitry according to the present disclosure in block diagrams;

FIG. 6 depicts a further embodiment of a time-of-flight data generation method for improving a depth of a frame based on a previous frame according to the present disclosure in a block diagram;

FIG. 7 depicts a further embodiment of a time-of-flight data generation method using a neural network according to the present disclosure in a block diagram;

FIG. 8 depicts a further embodiment of a time-of-flight data generation method using an optical flow according to the present disclosure in a block diagram;

FIG. 9 depicts a further embodiment of a time-of-flight data generation method according to the present disclosure in a block diagram, wherein a depth of two consecutive frames is fused when no motion is detected;

FIG. 10 depicts a further embodiment of a time-of-flight data generation method using an event count according to the present disclosure in a block diagram;

FIG. 11 depicts a further embodiment of a time-of-flight data generation method using motion information from events to correct motion artifacts according to the present disclosure in a block diagram;

FIG. 12 depicts a further embodiment of a time-of-flight data generation method for a generating high-speed depth according to the present disclosure in a block diagram;

FIG. 13 depicts a further embodiment of a time-of-flight data generation method for generating a high-speed depth in a neural network according to the present disclosure in a block diagram;

FIG. 14 depicts a further embodiment of a time-of-flight data generation method for performing intra-frame motion compensation according to the present disclosure in a block diagram;

FIG. 15 depicts a further embodiment of a time-of-flight data generation method for performing inter-frame motion compensation according to the present disclosure in a block diagram;

FIG. 16 depicts a further embodiment of a time-of-flight data generation method for generating a temporal super-resolution according to the present disclosure in a block diagram; and

FIG. 17 illustrates an embodiment of a time-of-flight imaging apparatus according to the present disclosure.

### DETAILED DESCRIPTION OF EMBODIMENTS

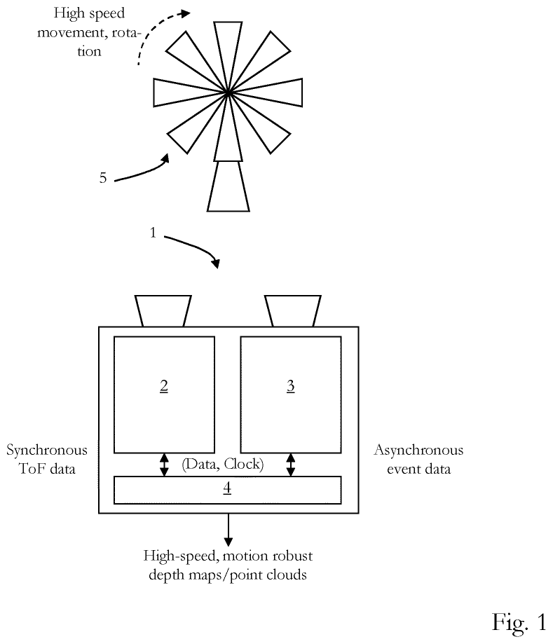

Before a detailed description of the embodiments starting with FIG. 1 is given, general explanations are made.

As mentioned in the outset, time-of-flight (ToF) devices are generally known. iToF as well as dToF may require an allocated time to obtain a frame for generating a depth map/point cloud. However, this time may be limited from below by a function of the illumination and sensor parameters since a number of sub-exposures or components may be processed per frame (this may also apply to structured light (SL) measurements or stereo camera measurements). Furthermore, sensor integration time, readout time and other illumination or sensor-specific properties, such as dead time and number of waveform repetitions may set a lower bound for a ToF measurement time.

A limit frame rate of the ToF sensor may then be: f_{ToF}=1/t_{frame}, wherein t_{frame} is the minimum time for obtaining a frame.

Furthermore, for obtaining a satisfying signal quality level, an illumination power and the integration time may, among others, be critical factors.

On the one hand, a long integration time may result in an increased signal-to-noise ratio (i.e., higher signal quality) but may cause motion artifacts since an object may have moved during the integration time.

On the other hand, a short integration time may reduce the impact of motion, but may result in a lower SNR and may considerably degrade the signal quality.

Thus, it has been recognized that motion artifacts may be reduced by fusing ToF data with high-speed information contained in an event-based sensor data stream.

If multiple frequencies or integration times are used to extend an operating range or the dynamic range of the ToF camera, the depth map would require more components per frame, and in doing so motion artifacts may be generated, if an object or element in the scene and/or the camera itself should move during the acquisition.

Furthermore, if multiple components are acquired, a frame rate at which depth maps are streamed may be further limited.

For example, if a fast-rotating object (e.g., a fan, a mill, an industrial gear) or any other motion (e.g., a rapid handwaving in front of a ToF camera, e.g., in a context of gesture recognition) should be imaged, a ToF camera may be limited above a certain movement speed.

It may be distinguished between intra-frame motion limitations, inter-frame motion limitations, and temporal resolution limitations, which will be discussed in the following, and to which some embodiments of the present disclosure pertain (alone or in combination).

i) Intra-Frame Motion Limitations

ToF may require several sub-exposures (sub-frames) or components to form a depth map. However, such ToF systems may be designed for the case that the camera and the scene are fixed during an acquisition. If the camera and/or the scene move, the resulting depth map may exhibit artifacts, e.g., in form of “double” fingers (in the case of a handwaving) or other object parts, incorrect object edges, or the like. In this case, the resulting depth map may not only be noisy, but also incorrect.

In known devices, this limitation may be overcome by sensor mosaicking, which may reduce a number of exposures, but which may also reduce a spatial resolution of the sensor. Furthermore, spatial interpolation techniques may be used which may create other artifacts.

In order to maintain the spatial resolution, the discrete character of measurements may be considered. For example, circuits for measuring the light in a ToF acquisition may be ordered in a certain way (i.e., a grid), thereby limiting positions at which measurements can be taken. If motion is involved, a measurement may fall on a non-grid location, such that it has been recognized that such non-grid locations can be taken into account for a measurement by utilizing event-based data over time. Thereby a spatial resolution may be improved.

Hence, it has been recognized that it is desirable to perform intra-frame motion compensation based on event data, such that artifacts may be avoided by using motion-corrected components.

ii) Inter-Frame Motion Limitations

Even if the camera and the scene remain fixed during the acquisition, a ToF depth map may be noisy, e.g., at a low integration time. The noise may be reduced by combining several consecutive frames with a temporal filter (e.g., simple averaging or weighted averaging, temporal bilateral filtering, or the like) provided the frames are motion-corrected, i.e., that the motion between frames is negligible.

Another way of overcoming this limitation is by using spatial denoising filters, but these may create other artifacts.

Hence, in order to increase a signal-to-noise ratio, it has been recognized to perform inter-frame motion compensation by combining motion-corrected frames.

iii) Temporal Resolution Limitations

As discussed above, a frame rate may be (physically) limited, whereas it is desirable to increase the frame rate. Since ToF is a synchronous depth sensing method, which may use periodic waveforms to resolve depth by either time or phase delay, it has been recognized to obtain a higher frame rate (or “temporal super-resolution”) of the depth maps (stream) by performing a frame interpolation by spatial and motion priors jointly with an event data stream or by data fusion with the priors.

For example, spatial priors may relate to spatial or spatio-temporal graph priors (e.g., Markov random fields) that enforce, e.g., piecewise-smooth depth map models using local connectivity between pixels/voxels.

Moreover, spatial priors may relate to global priors (e.g., sparsity, group sparsity, low rank) where each pixel/voxel affects the whole image/spatio-temporal volume when applying the prior to such a super-resolution task.

Such priors may include non-learned signal models that may be used to yield the most likely estimate (depth, in this context) given the data, the observations, and/or the measurements.

More generally speaking, priors may refer to a usage of filters, e.g. Kalman filters or other techniques, i.e. a system designer may assume certain properties based on knowledge or simplifications of physical processes involved and may use these to predict the state.

For example, in Bayesian techniques, this would result in a prior probability distribution over a state vector which is then corrected using measurements to extract a posterior probability distribution.

Examples of priors for motion may include motion models such as constant velocity, constant acceleration, or the like, both for the “world” (i.e. an environment) and an (image) sensor. From one depth frame to the other it is possible to assume constant depth or constant change in depth (or a constant motion, constant acceleration, or the like).

Hence, priors may be considered as inherent to a system design, and thus, may hold only as long as the underlying assumptions hold up, whereas, including events (as in the present disclosure) may integrate measurements at a higher temporal resolution.

For example, a constant-velocity assumption may be accurate the less time has passed and a prediction based on priors may become more inaccurate the more time passes.

In such embodiments, the temporal super-resolution may rely on measurements and, therefore, an asynchronous or high frame rate depth map or point cloud stream can be reconstructed more accurately than solely relying on priors (which are not based on events).

Apart from motion-compensation or the increase of (temporal or spatial) resolution, it has been recognized that not only motion may be determined, but it may also be possible to determine an absence of motion. In such embodiments, an upper bound (i.e., a threshold) on motion may be determined per pixel. If it is known that no or little motion (i.e., below a predetermined threshold) is present at a certain pixel, methods for improving a precision and/or SNR may be directly applied to multiple measurements from the same pixel without the need for motion-based warping methods (as will be discussed further below).

The upper bound may be determined based on events by employing any method that allows the estimation of motion from events.

For example, this may be applied on a measurement of reflectance properties of a surrounding of an object in a field of view. In this example, a reflectance neighborhood around the pixel may directly be used to estimate a maximal motion distance for a measured number of events triggered at the pixel in question by determining a change of reflectance based on the events and matching it to a displacement or motion on the reflectance neighborhood which would have caused these events.

Therefore, some embodiments pertain to time-of-flight data generation circuitry, configured to: acquire a time-of-flight data stream; acquire a brightness change event data stream; correlate the time-of-flight data stream with the brightness change event data stream in time with each other for generating at least one time-of-flight data frame; and generate the at least one time-of-flight data frame.

Circuitry may pertain to any wired or wireless data transmission/generation device, such as a CPU (central processing unit), GPU (graphics processing unit), FPGA (field-programmable gate array), a server, a computer, or the like. Also, multiple of such devices (also in combination) may pertain to circuitry according to the present disclosure. The circuitry may further be based on a ToF sensor (or pixel) and EVS/DVS (event-based vision sensor/dynamic vision sensor), a software pipeline, an image signal processor (ISP), or the like.

The software pipeline may receive the ToF data stream and the brightness change event data stream and may yield depth maps or point clouds.

Furthermore, the circuitry may be based on an EVS camera and a ToF camera, a hybrid EVS/ToF sensor, or the like.

However, as discussed above, circuitry may only pertain to a processor, such that the above-mentioned “fusion” pipeline may be realized.

Furthermore, the present disclosure may be applied to any frame-based time-of-flight technology, such as iToF or dToF, structured light depth sensing techniques (which may be based on an iToF sensor or any other sensor), or any other depth sensing technique, such as a LIDAR/RADAR-based approach, a stereo camera-based approach, or the like.

In some embodiments, the time-of-flight data generation circuitry is configured to acquire a time-of-flight data stream.

A data stream may include a sequence of data in time, such as consecutive data packets, consecutive (sub-)frames, or the like.

The ToF data stream may be indicative for at least one depth measurement or depth map, as it is generally known. For example, in case the ToF data stream is indicative of sub-frames, a depth map may be generated based on the ToF data stream, if the ToF data stream derives from one ToF acquisition process. If the ToF data stream is indicative of frames, multiple depth maps may be derived based on the ToF data stream. However, also from sub-frames multiple depth maps may be derived, as it is generally known.

As it is generally known, a frame may refer to a time-span in which a measurement is performed. Accordingly, a sub-frame is a time-span within the frame, in which a part of the measurement or a sub-measurement is performed. For example, in multiple sub-frames, multiple measurements may be carried out which may be put together in the frame.

In case of iToF, the ToF data stream may be based on an acquisition with at least one CAPD (current-assisted photonic demodulator) or based on an iToF chip (e.g., with a plurality of CAPDs as iToF pixels.)

Furthermore, a brightness change event data stream may be acquired, e.g., based on an EVS/DVS (event-based/dynamic vision sensor).

The brightness change event data stream may be indicative of a change of a brightness measured in one EVS/DVS sensor element (hereinafter referred to as event pixel). If the measured brightness in an event pixel is above a predetermined threshold, an event may be generated. Such brightness change events may be indicative of a movement/motion since a moving object may have an influence on detected light.

For example, the light may derive from a ToF light source, i.e., may be modulated light of an iToF camera, based on which a depth may be derived. Hence, a ToF pixel may be sensitive to the light from the ToF light source, whereas an EVS pixel may be sensitive to light of a different wavelength band, such that the wavelength bands at which the ToF pixel and the EVS pixel are sensitive to, do not overlap (which may be achieved with an IR (infrared) cut, for example), such that interference is avoided. Events may, in such embodiments, be caused by reflectance changes of ambient light, for example (or a different light source may be utilized, such that the disclosure may be carried out at no or little ambient light). From this, it may be concluded that an object has moved between the two consecutive points of time.

The ToF data stream may be synchronous, whereas the brightness change event data stream may be asynchronous since the nature of acquisition and readout of the two pixels may be different.

Thus, the two data streams are synchronized in time, e.g., based on correlation-based post processing techniques or based on hardware-based approaches (e.g. a clock circuit, master), such that timestamps of the data streams are aligned.

For example, in ToF, the acquisition in different ToF pixels may be synchronized due to a timing of a light source, based on a demodulation signal, on a trigger or clock signal (external or internal, in a master/slave arrangement), or the like.

However, an event pixel may be configured to detect a brightness change event at the very moment at which a brightness change occurs on the pixel-level. If there are two event pixels, a detection in each pixel may be indicative of the same or of a different motion.

Hence, in some embodiments, the ToF data stream and the brightness change event data stream are correlated in time with each other, such that a motion may be detected based on the brightness change event data stream for the ToF data stream.

Correlation may refer to an assigning of data points of the ToF data stream at points of time intrinsic to the ToF measurement to data points of the event data stream at points of time intrinsic to the event measurement. Hence, a correspondence between the ToF data stream and the event data stream may be established based on internal clocks, as indicated above.

Based on the correlation, a time-of-flight data frame may be generated. This may include correcting or changing an already existing frame, such that the detected motion may be unblurred in a final depth map. This may also include generating a completely new frame based on the data streams in case, a frame generation of the ToF acquisition has not happened yet. However, also in case a frame generation has already happened, at least one further frame may be generated between two frames in which the motion of the object is taken into account, such that a time-resolution of consecutive frames or depth maps is artificially increased by adding frames.

Hence, in some embodiments, a depth sensing may be improved, e.g., for mobile or handheld device applications with high-speed requirements, such that video refocusing, relighting, Bokeh effects and/or other augmented reality-based video effects may be enabled at predetermined frame rates. The present disclosure may also be applicable to (industrial) machine vision.

In some embodiments, the time-of-flight data stream is indicative of a plurality of sub-frames, as discussed herein.

Hence, intra-frame motion compensation may be carried out, as discussed above. In such embodiments, the brightness change event data stream may be used to compensate for motion between ToF components (or between the sub-frames), such that a higher precision depth map or point cloud stream may be obtained at ToF frame rate.

In some embodiments, the time-of-flight data generation circuitry is further configured to: determine a relative motion of an object within the plurality of sub-frames based on the brightness change event data stream.

The motion of the object may be relative with respect to another object and/or the camera (i.e. the camera may move, whereas the object remains still, such as in ego-motion, as will be discussed further below).

For example, when the (brightness change) event data stream is correlated in time with the ToF data stream, it may be determined which event(s) of the event data stream correlates with which subframe of the ToF data stream. Hence, a position of the object may be determined for each sub-frame.

The object may include, for example, a hand, a ball, a bird, or any other object which may possibly move or be moved. The object does not need to be determined as it is sufficient to determine the motion, such that the object may be any object or part of an object.

Moreover, a position of a camera (adapted to generate ToF and event data streams according to the present disclosure) with respect to a scene and/or to the object may change (also referred to as “egomotion”), for example due to intentional movement of the camera (e.g., navigation in an environment), or to nuisances (e.g., mechanical vibrations, shaking hands, movement during physical exercise, or the like).

However, if the position of the object is different in each sub-frame, in a resulting depth map the position of the object may be blurred since the different positions may be indicative for different depths. Therefore, it is desirable to compensate for such an erroneous depth caused by the motion (or to compensate for the motion).

Hence, in some embodiments, the time-of-flight data generation circuitry is further configured to: determine a position of the object based on one sub-frame for compensating for the motion in the at least one time-of-flight data frame.

The position may be based on each position of each sub-frame. For example, it may be decided for one position (e.g., the position of the last sub-frame) or it may be a (weighted) mean position, or the like. The position may further be based on a prediction (e.g., based on a prediction vector), or the like.

However, the claimed subject-matter is not limited to the position being different in sub-frames since the position may also differ in frames, such that, based on the motion, a dynamic range of a resulting depth map may be decreased and/or such that the resulting depth map may have a low signal to noise ratio (SNR).

Hence, in some embodiments, the time-of-flight data stream is indicative of a plurality of frames, as discussed herein.

Thereby, inter-frame motion compensation may be carried out, as described above.

In such embodiments, the brightness change event data stream may be utilized to compensate motion between ToF frames and to obtain a higher SNR at ToF frame rate.

In some embodiments, the time-of-flight data generation circuitry is further configured to: determine a relative motion of an object in the plurality of frames based on the brightness change event data stream; and determine a depth of a current frame based on a depth of a previous frame.

The object may also refer to a part, an element, a scene. The motion may be a motion relative to the camera, for example (e.g., the object may be still, but the camera may move, e.g., ego-motion)

Similar to the determination of the motion as described for the sub-frames, after the correlation of the ToF data stream and the event data stream, different positions of the object in the ToF data stream may be determined based on the event data stream, such that the object may be blurred in a resulting depth map.

Hence, the position of the object (and thereby the depth for pixels indicative of the object and surrounding pixels) may be determined based on a depth of a previous frame.

In other words: the depth of the previous frame may be indicative of the depth of the current frame, e.g., in that the depth is (roughly) the same (since e.g., the object only moved below a predetermined threshold) or in that a position of the object may be predicted based on a determined motion of the previous frame.

In some embodiments, the depth of the current frame is further determined based on a relative intensity change indicated by the brightness change event data stream.

As it is generally known, brightness change events may be indicative of a relative light intensity (change). Thus, if the light intensity changes for an event pixel which may be correlated with a ToF pixel, it may also be indicative of a depth change since an object may have moved.

In some embodiments, the time-of-flight data generation circuitry is further configured to: determine a relative motion of an object in the plurality of frames based on the brightness change event data stream; and generate at least one frame in between two of the plurality of frames based on the motion of the object, such that a time-resolution of the time-of-flight data stream is increased.

The frame may be generated based on an estimated position which may be estimated based on the determined motion. The generated frame may have a similar or a same depth as the previous or the next frame in the background, but the position of the object may lie in between the respective positions of the two frames.

In the previous frame, some of the background depths may not be determinable based on the previous frame since they may be covered by the object, whereas partly other background depths in the next frame may be covered by the object, such that they may not be determinable directly from the next frame. Hence, in the generated frame, the background pixels of the previous and the next frame may be taken into account for generating the depth map of the generated frame.

Thereby, a temporal super-resolution may be achieved, as described above. In such embodiments, the brightness change event data stream may be used to estimate a motion between ToF frames and to obtain a higher arbitrary or (a)synchronous frame rate.

Generally, according to the present disclosure, a simpler and more precise way is given for compensating for motion and/or for increasing a time-resolution than equivalent tasks without the usage of events (i.e., not by data fusion, but by approximation with priors). Furthermore, the three motion compensation techniques can be combined in any fashion. For example, an intra-frame motion compensation, an inter-frame motion compensation and/or a temporal super-resolution may be envisaged.

In some embodiments, the correlation is based on an optical flow integration.

The optical flow may be determined based on the event data stream. For example, a first event may be determined in a first pixel at a first point of time, and a second event may be determined in a second pixel at a second (later) point of time. The optical flow may then be a motion vector based on the position of the first pixel with respect to the second pixel versus time (i.e., a velocity).

Hence, for integrating the optical flow, a plurality of optical flow velocities (each for a depth measurement) may be determined, which may be integrated over time, such that a correspondence between each depth measurement may be established based on the optical flow velocities.

For example, a flow integration may be started in parallel or based on an acquisition of a depth n and may be stopped when the next depth acquisition starts, which may in turn trigger a new optical flow integration. For pixels, in which an optical flow is known, the depth n (or the (sub-)frames of the depth acquisition n) may be taken into account for determining the depth n+1.

In some embodiments, the correlation is based on a brightness change event count.

The events may be counted with respect to a predetermined area on the event sensor (chip). A single pixel may already correspond to the predetermined area, whereas also multiple of (connected) pixels may establish such an area. Hence, for a brightness change event count, all events within a predetermined time-span may be counted.

The event count may be started after a depth n is acquired and may be stopped when a next depth n+1 is acquired and a new event count for depth n+1 may be started. If a relative intensity change between n and n+1 in an area is below a predetermined threshold, it may be inferred that the depth for this area has not changed, such that the depth of n (or the (sub-)frames of the depth measurement n) may be taken into account for determining the depth n+1, such that an improved depth n+1 may be determined. This may also be applicable for the generation of confidence images instead of depth maps.

Some embodiments pertain to a time-of-flight data generation method, including: acquiring a time-of-flight data stream; acquiring a brightness change event data stream; correlating the time-of-flight data stream with the brightness change event data stream in time with each other for generating at least one time-of-flight data frame; and generating the at least one time-of-flight data frame, as discussed herein.

The ToF data generation method may be carried out with ToF data generation circuitry, as discussed herein.

In some embodiments, the time-of-flight data stream is indicative of a plurality of sub-frames, as discussed herein. In some embodiments, the time-of-flight data generation method further includes: determining a relative motion of an object within the plurality of sub-frames based on the brightness change event data stream, as discussed herein. In some embodiments, the time-of-flight data generation method further includes: determining a position of the object based on one sub-frame for compensating the motion in the at least one time-of-flight data frame, as discussed herein. In some embodiments, the time-of-flight data stream is indicative of a plurality of frames, as discussed herein. In some embodiments, the time-of-flight data generation method further includes: determining a relative motion of an object in the plurality of frames based on the brightness change event data stream; and determining a depth of a current frame based on a depth previous frame, as discussed herein. In some embodiments, the depth of the current frame is further determined based on a relative intensity change indicated by the brightness change event data stream, as discussed herein. In some embodiments, the time-of-flight data generation method further includes: determining a relative motion of an object in the plurality of frames based on the brightness change event data stream; and generating at least one frame in between two of the plurality of frames based on the motion of the object, such that a time-resolution of the time-of-flight data stream is increased, as discussed herein. In some embodiments, the correlation is based on an optical flow integration, as discussed herein. In some embodiments, the correlation is based on a brightness change event count, as discussed herein.

In some embodiments, the data generation method is carried out in a neural network (NN). The NN may run on a dedicated processing unit, such as a tensor processing unit or GPU (which may then constitute (at least a part of) the data generation circuitry disclosed herein).

The NN may have depth data and event data as inputs. For example, a ToF measurement may be represented as a two-dimensional one-channel depth map or a two-dimensional two-channel featuring both a depth estimate and a corresponding confidence per pixel. Event representations may include fix-sized batches, voxel grids representing space-time, or the like.

The NN may output an estimated depth map based on the fusion of EVS and ToF measurements or a depth map with corresponding confidences.

The NN may be trained based on simulated data in which estimated depth values may be compared to ground truth using an appropriate loss function, such as mean squared error or comparing the predicted/NN estimated depth for a time in which a depth measurement is available to the measurement received. The NN may further be trained to learn a relationship between EVS and ToF data by training it on data generated from video, for example (while also using a suitable loss function).

However, according to the present disclosure, the NN may be additionally or alternatively trained based on real data captured by a system including both a ToF and an EVS sensor, or trained based on using a pre-trained network (on synthetic data) and then fine-tune the NN (algorithm) on real data (and/or perform domain adaption).

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is schematically depicted time-of-flight data generation circuitry 1 according to the present disclosure, which is, in this embodiment, implemented as a dual ToF/EVS camera.

Accordingly, the ToF data generation circuitry 1 includes a ToF camera 2 generating a ToF data stream and an EVS camera 3 generating a brightness change event data stream.

However, as discussed herein, the ToF data stream is synchronous and the event data stream is asynchronous, such that the data is synchronized based on a clock and transmitted to an image signal processor (ISP) 4.

The ToF data generation circuitry is adjusted to picture an object 5 which carries out a high speed movement (rotation). To compensate for the motion, the ISP 4 is configured to carry out a ToF data generation method according to the present disclosure, such that high-speed and motion robust depth maps/point clouds can be generated.

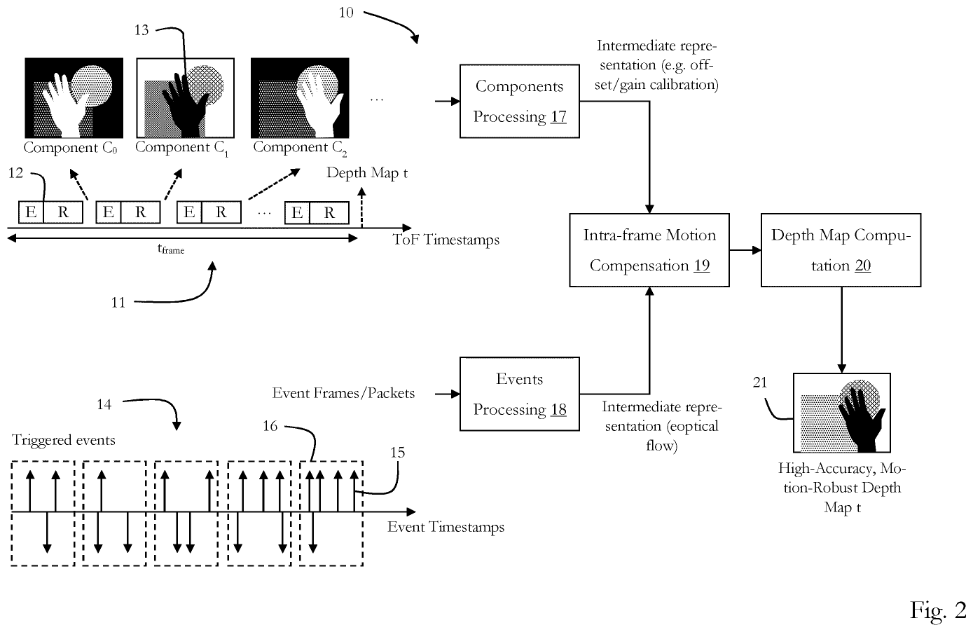

FIG. 2 depicts a time-of-flight data generation method 10 according to the present disclosure. In this embodiment, intra-frame motion compensation is carried out.

Generally speaking, before a detailed description of FIG. 2 is given, events are processed in packets or frames based on spatio-temporal adjacency, such that all event are obtained which have occurred during the capture of components Cᵢ(i=0, . . . , N−1). Each component corresponds to a sub-exposure and may therefore be based on a sub-frame, as it is the case for iToF.

A components processing block pre-processes the component values, e.g., by calibrating the gains and offsets of a read component.

An events processing part yields an intermediate representation convenient for the fusion task at hand. For example, a dense optical flow between the components may be computed by using the events.

For the fusion of the respective data streams, the intermediate representations are used for each component for correcting a motion and warp each component pixel up to its final location in the last component. For example, a bundle of estimated dense optical flows may be used to perform this warping, such that the motion compensation is carried out by alignment of the motion to the last component, without limiting the present disclosure in that regard.

In the context of gesture recognition, if a hand (as the object) is moved rapidly in front of the ToF system, it is possible to align the ToF components and avoid motion artifacts inherent to using subexposures (sub-frames) in depth sensing. In some embodiments, the fusion is carried out based on a convolutional neural network (CNN) trained with the intermediate representations of the brightness change event data stream and the ToF data stream as inputs, and the motion-corrected depth map as output.

Returning to FIG. 2, at 11, a ToF data stream is acquired including a plurality of sub-frames 12 being indicative for a depth map t, wherein each sub-frame 12 include a time of exposure (E) and a time for readout (R). Based on each sub-frame 12, components C₀ to C₂ (and so on) are derived, wherein the components are indicative for a scene, as it is generally known.

The sub-frames 12 are generated consecutively, i.e., for each sub-frame 12 a timestamp is generated.

During the ToF acquisition, an object 13 (a hand, in this embodiment) moves within the field of view, such that the hand 13 has a different position at each component. In a resulting depth map, this would lead to a blurred display of the hand 13.

At 14, a brightness change event data stream is acquired which is indicative of a plurality of events 15, as discussed herein. In this embodiment, it can be distinguished between positive events (upwards facing arrow) and negative events (downwards facing arrow), i.e., an event polarity can be determined. However, it may also be sufficient to just detect an event irrespective of its polarity.

The brightness change event data stream is already based on event timestamps 16, i.e., each event 15 is assigned to a timing.

At 17, the components from the ToF data stream are processed and at 18, the events are processed. Furthermore, the streams are correlated in time, such that the ToF timestamps and the event timestamps have a correspondence.

Based on the components processing and the events processing, respective intermediate representations are derived.

At 19, an intra-frame motion compensation is carried out, i.e., based on the correlated data streams, a ToF frame is generated, such that a depth map is computed, at 20, resulting in a depth map 21.

For compensating for the motion, in the resulting depth map, it has been decided to use the position of the hand 13 as it is in component C₂, such that the hand 13 is not blurred in the final depth map 21.

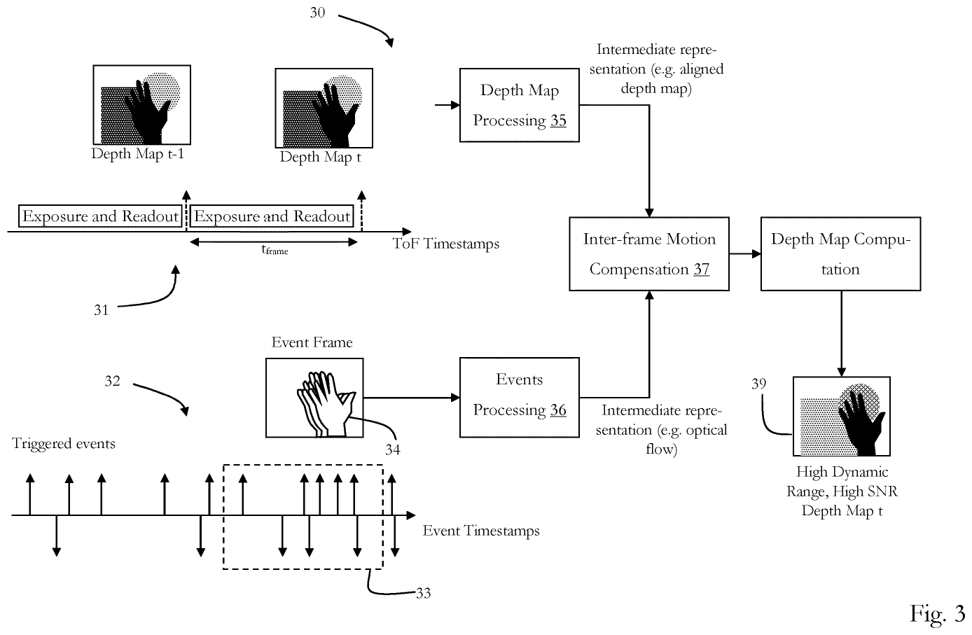

FIG. 3 depicts a further embodiment of a ToF data generation method 30 according to the present disclosure. In this embodiment, inter-frame motion compensation is carried out.

Generally speaking, before a detailed description of FIG. 3 is given, a brightness change event data stream is processed in frames (as discussed under reference of FIG. 2), but in this embodiments, all events are collected which have occurred during the capture of two consecutive depth maps (or point clouds).

A depth map processing block pre-processes the depth maps, e.g., by denoising, point cloud computation, or global alignment in case pose information is available.

An events processing block yields an intermediate representation convenient for the fusion.

For example, a dense optical flow between the depth maps may be computed by using the event data stream.

The dense optical flow is used to warp a previous depth map to its corresponding pixels in a current depth map and then average the two depth maps to increase the SNR, which can be applied to both scene-motion and ego-motion.

In the context of gesture recognition: if a hand moves rapidly in front of the camera, it is possible to average the motion-corrected depth maps and reduce the impact of noise. In this embodiment, such as in the previous embodiment, the fusion can be carried out by a CNN trained with the intermediate representation as inputs and the motion-corrected depth map as output.

Returning to FIG. 3, at 31, a ToF data stream is acquired including a previous depth map t−1 and a current depth map t.

At 32, a brightness change event data stream is acquired, wherein an event frame 33 is displayed. However, within the event frame, an object 34 (a hand, in this embodiment) has moved, which is determined based on the event data stream.

At 35, a depth map processing is carried out, such that an intermediate depth map representation is generated.

At 36, an events processing is carried out, such that an intermediate event representation is generated.

At 37, an inter-frame motion compensation is carried out, as discussed herein, such that a frame is generated based on which a depth map is computed, at 38, resulting in a depth map 39 with a high dynamic range and a high SNR. The depth map 39 corresponds to the depth map t (i.e., the current depth map as described above), but with improvements based on the previous depth map t−1 and the event frame.

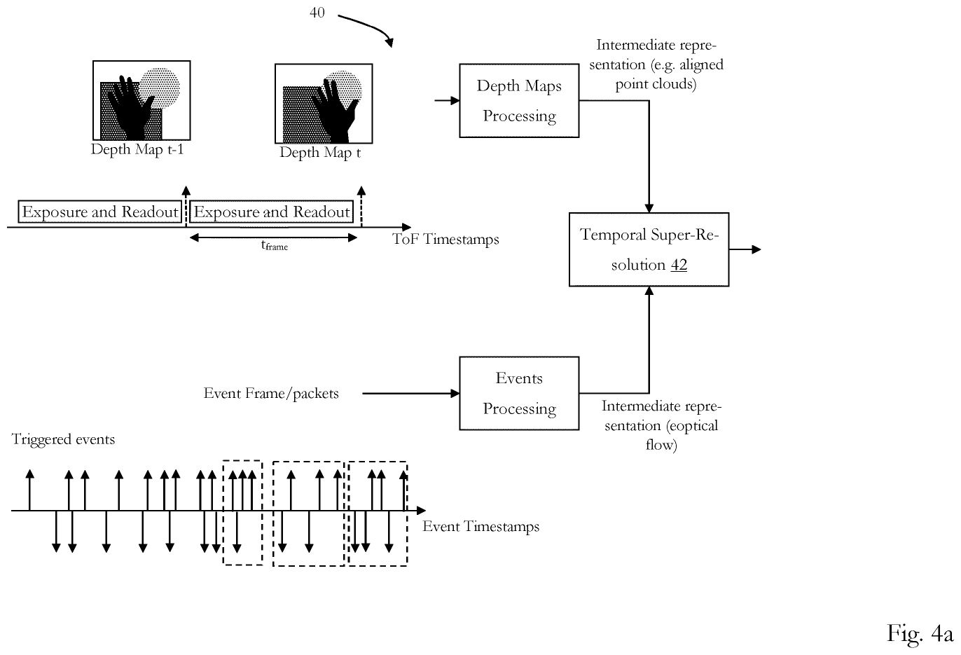

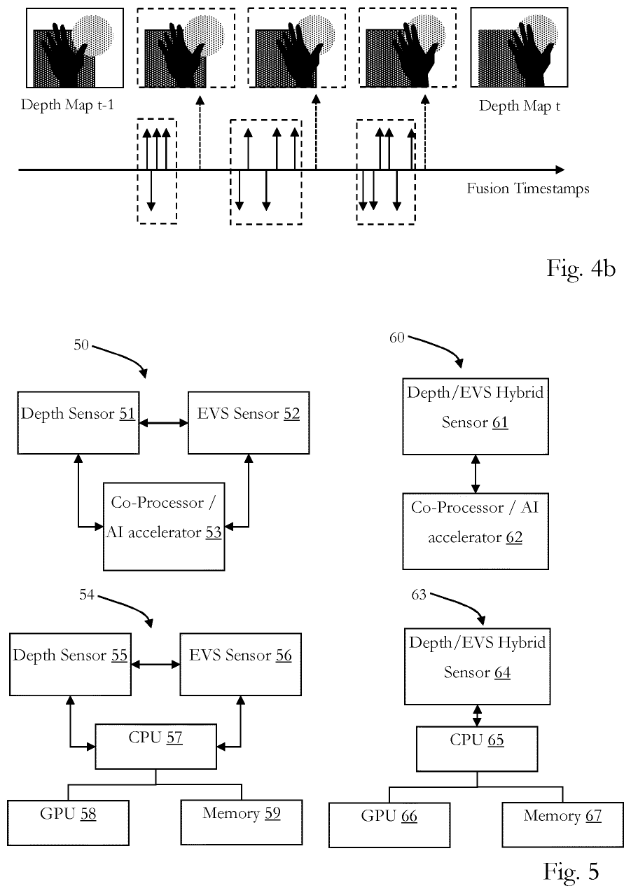

FIGS. 4a and 4b depict a further embodiment of a ToF data generation method 40 according to the present disclosure.

In this embodiment, temporal super-resolution is generated.

Generally speaking, before a detailed description of FIG. 4 (a and b) is given, the event data stream is used to increase the frame rate of the ToF sensor. In other words: depth maps (or frames) occurring between two ToF frames are constructed.

If the imaged scene is a rotating or moving object in front of a foreground, motion estimates from the event data stream is used to infer the motion between two consecutive ToF frames. Depending on how the event packets are chosen and processed, the output depth map or point cloud stream will be synchronous at higher frame rate than that of “usual” ToF, or it will be asynchronous.

A depth map processing block yields processed depth maps, e.g., by point cloud computation.

An events processing block yields intermediate representations (being indicative for motion between frames) for event packets, wherein a grouping of the events depends on the desired frame rate. That means the grouping will be uniform in timestamp bins if a synchronous frame rate is desired or in asynchronous timestamp cluster if an asynchronous frame rate is desired.

A temporal super-resolution block infers depth maps or point clouds between the ToF frames using the two data streams which are fused, as discussed herein. The temporal super-resolution block can use priors to model motion (e.g., rotation, rigid motion in the scene, ego-motion, or the like) and infer it from the events, as well as spatial priors (e.g., smoothness, image morphology) to preserve the properties of the depth map (or point cloud).

For example, a dense optical flow may be calculated from event packets between two (or more) ToF frames (also referred to as keyframes) to warp the keyframes at the locations of the event packets (e.g., in a forward-backward fashion to enforce consistency between warped frames and the two keyframes).

The dense optical flow may also be obtained based on previous depth and event data, which may be stored, for example, in a storage. Furthermore, the two (or more) frames do not need to be successive frames and a corresponding frame distances may be adapted by the person skilled in the art.

A CNN can be used trained on events and depth maps to achieve such a warping, as discussed above.

Returning to FIG. 4a: As in FIG. 3, a ToF data stream and an event data stream are acquired, such that a repetitive description thereof is omitted. However, in contrast to FIG. 3, the brightness change event data stream is processed in packets 41 (multiple event frames), such that these packets are indicative of different positions of the hand.

The events and the depth maps are processed, such that, at 42, a temporal super-resolution data stream is obtained based on a plurality of newly generated frames in which the position of the hand is determined based on the packets 41.

Hence, as shown in FIG. 4b, between the depth maps t−1 and t, three frames (depth maps) are inserted based on the packets 41, wherein each of the three inserted frames, the hand position is different.

FIG. 5 depicts, in block diagrams, different embodiments of ToF data generation circuitry according to the present disclosure.

ToF data generation circuitry 50 includes a depth sensor 51 and and EVS sensor 52, which communicate with each other and with a co-processor/AI accelerator 53.

ToF data generation circuitry 54 includes a depth sensor 55 and and EVS sensor 56, which communicate with each other. Furthermore, each of the depth sensor 55 and EVS sensor 56 are coupled with a CPU 57, wherein the CPU 57 is further coupled with a GPU 58 and a memory 59.

ToF data generation circuitry 60 includes a hybrid depth/EVS sensor 61, i.e., a sensor which includes ToF pixels as well as EVS pixels. The sensor 61 communicated with a co-processor/AI accelerator 62.

ToF data generation circuitry 63 includes a hybrid depth/EVS sensor 64, which communicated with a CPU 65. The CPU 65 is coupled with a GPU 66 and a memory 67.

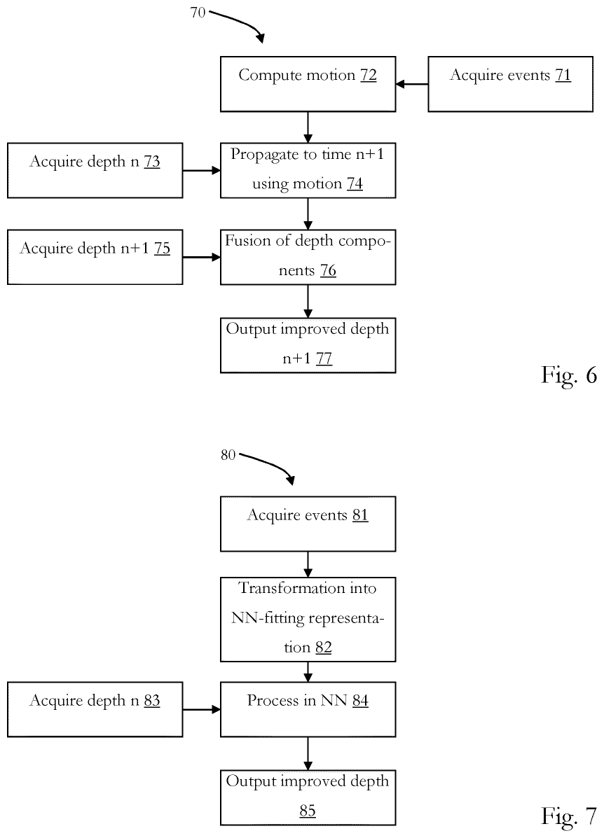

FIG. 6 depicts a further embodiment of a ToF data generation method 70 according to the present disclosure in a block diagram.

At 71, events are acquired, such that a brightness change event data stream is generated.

At 72, based on the events, a motion of an object is computed.

At 73, a depth for a frame n (depth n) is acquired.

At 74, a timestamp is propagated to n+1 using the motion computed at 72.

At 75, a depth for a frame n+1 (depth n+1) is acquired.

At 76, based on the depth n and n+1, depth components are fused for ToF pixels for which no motion is detected, such that at 77, an improved depth n+1 is output.

FIG. 7 depicts a further embodiment of a ToF data generation method 80 according to the present disclosure in a block diagram

At 81, events are acquired (i.e., a brightness change event data stream), as discussed herein.

At 82, the data stream is transformed into a representation which can be input into a neural network (NN).

At 83, a depth is acquired, which is also input into the NN, such that, at 84, the two data streams are processed in the NN, which has been trained to improve ToF data based on event data.

At 85, an improved depth is output.

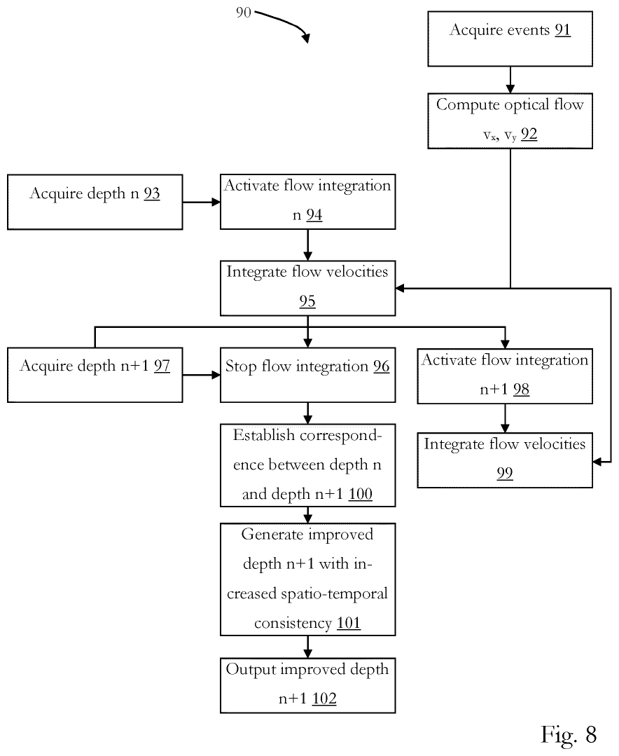

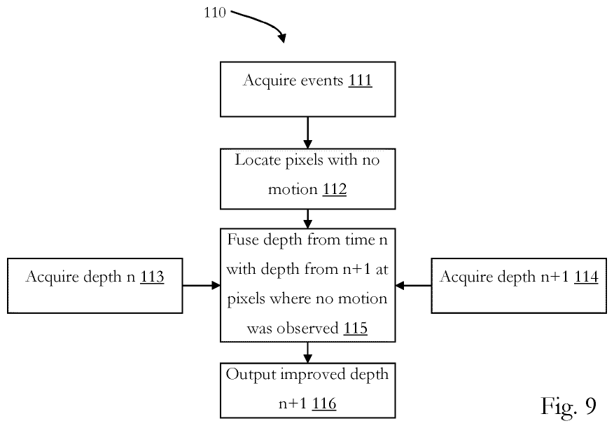

FIG. 8 depicts a further embodiment of a ToF data generation method 90 according to the present disclosure.

In this embodiment, the frames are generated based on an optical flow determined based on the event data stream.

Hence, at 91, events are acquired based on which an optical flow is computed at 92 (i.e., optical flow velocity components vₓ and v_{y} are computed).

At 93, a depth n is acquired.

At 94, a flow integration for the optical flow of frame n is activated.

At 95, the flow velocities are integrated, such that the flow integration (for frame n) is stopped at 96.

Furthermore, at 97, a depth acquisition for frame n+1 is started, which triggers a further flow integration, at 98 and 99.

At 100, a correspondence between depth n and depth n+1 is established based on the respective optical flows.

At 101, an improved depth n+1 with increased spatio-temporal consistency is generated.

At 102, the improved depth n+1 is output.

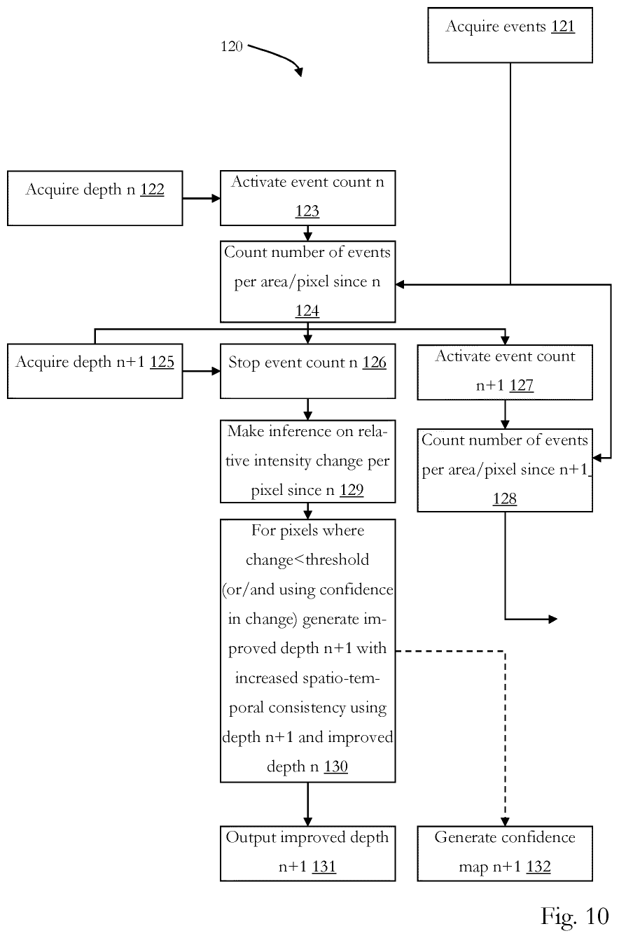

FIG. 9 depicts a further embodiment of a ToF data generation method 110 according to the present disclosure in a block diagram.

At 111, events are acquired, as discussed herein.

At 112, based on the detected events, event pixels and corresponding ToF pixels for which no motion is detected are located.

At 113, a depth n is acquired and at 114, a depth n+1 is acquired, as discussed herein.

At 115, depth n (i.e., the respective components and/or frames) is used for determining an improved depth n+1 for pixels for which no motion was observed.

At 116, the improved depth n+1 is output.

FIG. 10 depicts a further embodiment of a ToF data generation method 120 according to the present disclosure in a block diagram.

At 121, events are acquired, as discussed herein.

At 122, a depth n is acquired, as discussed herein.

At 123, an event count is activated while the depth for frame n is acquired (hence an event count n is acquired).

At 124, the number of events is counted per area/pixel since the depth acquisition n has started, as discussed herein.

At 125, a depth n+1 is acquired, such that, at 126, the event count n is stopped and a new event count n+1 is activated at 127. At 128, the number of events is counted per area/pixel since the depth acquisition n+1 has started.

At 129, an inference on a relative intensity change per pixel since depth acquisition n is made, such that, at 130, an improved depth n+1 can be generated, if the relative intensity change is below a pre-determined threshold, as discussed herein.

At 131, an improved depth n+1 is output.

Optionally, at 132 a confidence map n+1 is generated, if necessary.

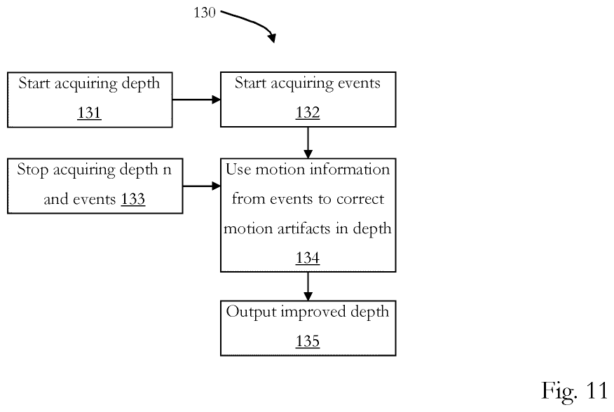

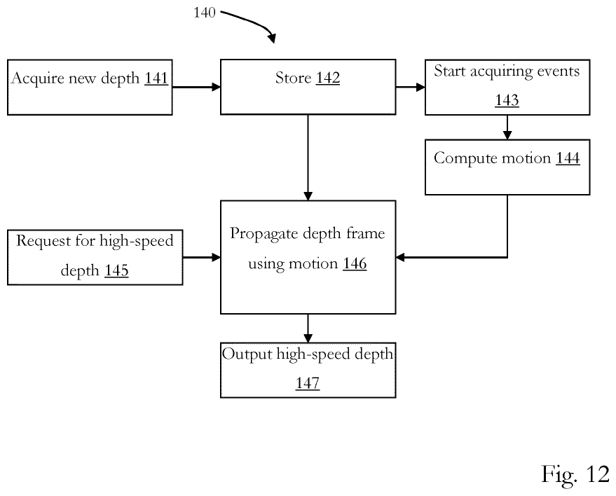

FIG. 11 depicts a further embodiment of a ToF data generation method 130 according to the present disclosure.

At 131, a depth acquisition is started.

At 132, an event acquisition is started.

At 133, the depth and event acquisitions are stopped.

At 134, motion artifacts in the determined depth are corrected based on motion information determined based on the events.

At 135, an improved depth is output.

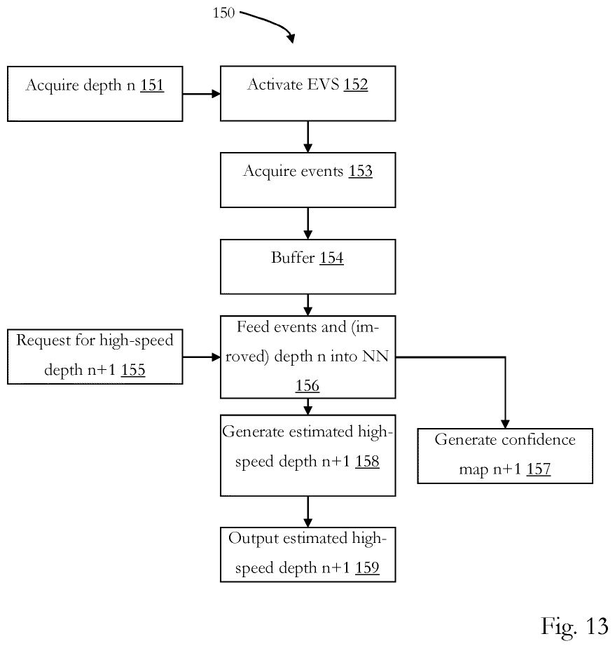

FIG. 12 depicts a further embodiment of a ToF data generation method 140 according to the present disclosure.

At 141, a depth is acquired, as discussed herein.

At 142, the depth is stored in a memory.

At 143, an event acquisition is started.

Based on the acquired events, a motion is computed at 144.

At 145, it is requested for high-speed depth, i.e., a ToF data stream with a high temporal resolution (i.e., higher than achievable with only a depth measurement).

At 146, a depth frame is propagated using the motion, i.e., a new depth frame is generated taken the motion into account without performing a new ToF measurement.

At 147, the high-speed depth is output.

FIG. 13 depicts a further embodiment of a ToF data generation method 150 according to the present disclosure in a block diagram.

At 151, a depth n is acquired, as discussed herein.

At 152, an EVS is activated, such that at 153, events are acquired, which are buffered at 154 (however, the buffering is not necessarily performed, in some embodiments).

At 155, it is requested for high-speed depth n+1.

At 156, the events and depth n are fed into an NN.

At 157, a confidence map n+1 is generated by the NN.

At 158, a high-speed depth n+1 is generated by the NN.

At 159, the high-speed depth n+1 is output.

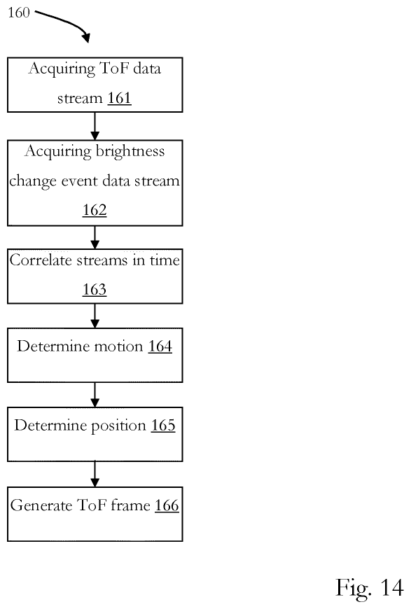

FIG. 14 depicts a further embodiment of a ToF data generation method 160 according to the present disclosure in a block diagram.

At 161, a ToF data stream is acquired which is indicative of a plurality of sub-frames.

At 162, a brightness change event data stream is acquired, as discussed herein.

At 163, the data streams are correlated in time, as discussed herein.

At 164, a motion of an object is determined within the plurality of sub-frames based on the brightness change event data stream, as discussed herein.

At 165, a position of the object is determined based on one sub-frame for compensating for the motion in the at least one time-of-flight data frame, as discussed herein.

At 166, a ToF data frame is generated based on the sub-frames and based on the determined position, as discussed herein.

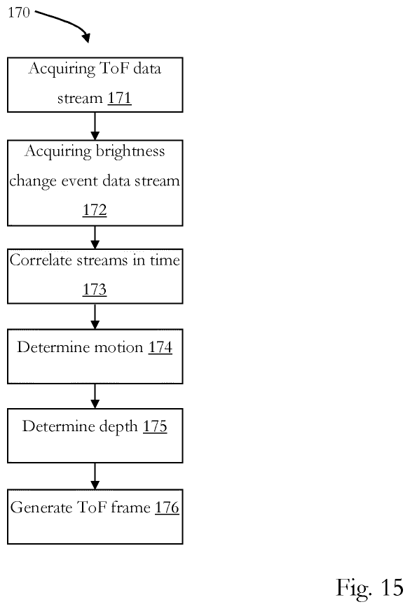

FIG. 15 depicts a further embodiment of a ToF data generation method 170 according to the present disclosure in a block diagram.

At 171, a ToF data stream is acquired which is indicative of a plurality of frames.

At 172, a brightness change event data stream is acquired, as discussed herein.

At 173, the data streams are correlated in time, as discussed herein.

At 174, a motion of an object is determined within the plurality of frames based on the brightness change event data stream, as discussed herein.

At 175, a depth of a current frame is determined based on a depth of a previous frame, as discussed herein.

At 176, a ToF frame is generated for the current frame with an improved depth based on the previous frame, as discussed herein.

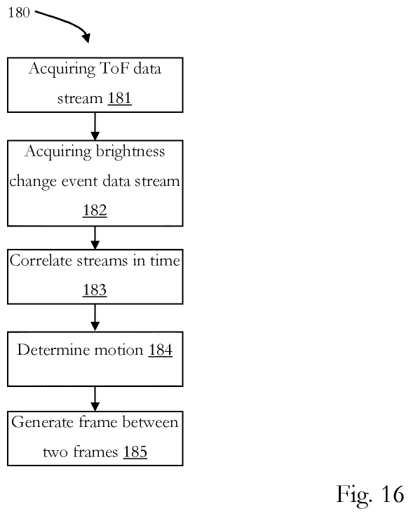

FIG. 16 depicts a further embodiment of a ToF data generation method 180 according to the present disclosure in a block diagram.

At 181, a ToF data stream is acquired which is indicative of a plurality of frames.

At 182, a brightness change event data stream is acquired, as discussed herein.

At 183, the streams are correlated in time, as discussed herein.

At 184, a motion of an object in the plurality of frames in determined based on the brightness change event data stream, as discussed herein.

At 185, a frame is generated between two of the plurality of frames based on the motion of the object, such that a time-resolution of the ToF data stream is increased, as discussed herein.

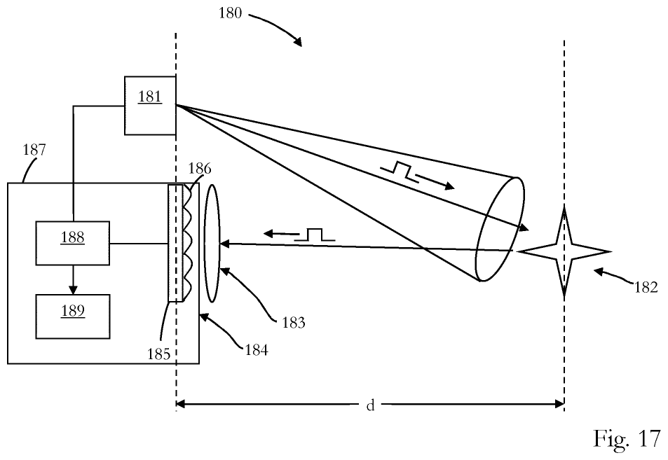

Referring to FIG. 17, there is illustrated an embodiment of a time-of-flight (ToF) imaging apparatus 180, which can be used for depth sensing or providing a distance measurement, in particular for the technology as discussed herein, wherein the ToF imaging apparatus 180 is configured as an iToF camera. The ToF imaging apparatus 180 has a hybrid image sensor circuitry 187 (including an EVS and an iToF sensor, as discussed herein), which is configured to perform the methods as discussed herein and which forms a control of the ToF imaging apparatus 180 (and it includes, not shown, corresponding processors, memory and storage, as it is generally known to the skilled person).

The ToF imaging apparatus 180 has a modulated light source 181 and it includes light emitting elements (based on laser diodes), wherein in the present embodiment, the light emitting elements are narrow band laser elements.

The light source 181 emits light, i.e., modulated light, as discussed herein, to a scene 182 (region of interest or object), which reflects the light. The reflected light is focused by an optical stack 183 to a light detector 184.

The light detector 184 is implemented based on multiple CAPDs formed in an array of pixels and a micro lens array 186 which focuses the light reflected from the scene 182 to the hybrid imaging portion 185 (to each pixel of the image sensor circuitry 187).

The light emission time and modulation information is fed to the hybrid image sensor circuitry or control 187 including a time-of-flight measurement unit 188, which also receives respective information from the hybrid imaging portion 185, when the light is detected which is reflected from the scene 182. On the basis of the modulated light received from the light source 181, the time-of-flight measurement unit 188 computes a phase shift of the received modulated light which has been emit-ted from the light source 181 and reflected by the scene 182 and on the basis thereon it computes a distance d (depth information) between the hybrid imaging portion 185 and the scene 182.

The depth information is fed from the time-of-flight measurement unit 188 to a 3D image reconstruction unit 189 of the hybrid image sensor circuitry 187, which reconstructs (generates) a 3D image of the scene 182 based on the ToF data stream and based on an event data stream, as discussed herein.

It should be recognized that the embodiments describe methods with an exemplary ordering of method steps. The specific ordering of method steps is however given for illustrative purposes only and should not be construed as binding. For example, the ordering of 91 and 93 in the embodiment of FIG. 8 may be exchanged. Also, the ordering of 121 and 122 in the embodiment of FIG. 10 may be exchanged. Further, also the ordering of 161 and 162 in the embodiment of FIG. 14 may be exchanged. Other changes of the ordering of method steps may be apparent to the skilled person.

Please note that the division of the control 187 into units 188 and 189 is only made for illustration purposes and that the present disclosure is not limited to any specific division of functions in specific units. For instance, the control 187 could be implemented by a respective programmed processor, field programmable gate array (FPGA) and the like.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) Time-of-flight data generation circuitry, configured to:
acquire a time-of-flight data stream;
acquire a brightness change event data stream;
correlate the time-of-flight data stream with the brightness change event data stream in time with each other for generating at least one time-of-flight data frame; and generate the at least one time-of-flight data frame.

(2) The time-of-flight data generation circuitry of (1), wherein the time-of-flight data stream is indicative of a plurality of sub-frames.

(3) The time-of-flight data generation circuitry of (2), further configured to:
determine a relative motion of an object within the plurality of sub-frames based on the brightness change event data stream.

(4) The time-of-flight data generation circuitry of (2) or (3), further configured to:
determine a position of the object based on one sub-frame for compensating for the motion in the at least one time-of-flight data frame.

(5) The time-of-flight data generation circuitry of anyone of (1) to (4), wherein the time-of-flight data stream is indicative of a plurality of frames.

(6) The time-of-flight data generation circuitry of (5), further configured to:
determine a relative motion of an object in the plurality of frames based on the brightness change event data stream; and determine a depth of a current frame based on a depth of a previous frame.

(7) The time-of-flight data generation circuitry of (6), wherein the depth of the current frame is further determined based on a relative intensity change indicated by the brightness change event data stream.

(8) The time-of-flight data generation circuitry of anyone of (5) to (7), further configured to:
determine a relative motion of an object in the plurality of frames based on the brightness change event data stream; and
generate at least one frame in between two of the plurality of frames based on the motion of the object, such that a time-resolution of the time-of-flight data stream is increased.

(9) The time-of-flight data generation circuitry of anyone of (1) to (8), wherein the correlation is based on an optical flow integration.

(10) The time-of-flight data generation circuitry of anyone of (1) to (9), wherein the correlation is based on a brightness change event count.

(11) A time-of-flight data generation method, comprising:
acquiring a time-of-flight data stream;
acquiring a brightness change event data stream;
correlating the time-of-flight data stream with the brightness change event data stream in time with each other for generating at least one time-of-flight data frame; and generating the at least one time-of-flight data frame.

(12) The time-of-flight data generation method of (11), wherein the time-of-flight data stream is indicative of a plurality of sub-frames.

(13) The time-of-flight data generation method of (12), further comprising:
determining a relative motion of an object within the plurality of sub-frames based on the brightness change event data stream.

(14) The time-of-flight data generation method of (13) or (14), further comprising: determining a position of the object based on one sub-frame for compensating for the motion in the at least one time-of-flight data frame.

(15) The time-of-flight data generation method of anyone of (11) to (14), wherein the time-of-flight data stream is indicative of a plurality of frames.

(16) The time-of-flight data generation method of (15), further comprising:
determining a relative motion of an object in the plurality of frames based on the brightness change event data stream; and
determining a depth of a current frame based on a depth of a previous frame.

(17) The time-of-flight data generation method of (16), wherein the depth of the current frame is further determined based on a relative intensity change indicated by the brightness change event data stream.

(18) The time-of-flight data generation method of anyone of (15) to (17), further comprising:
determining a relative motion of an object in the plurality of frames based on the brightness change event data stream; and
generating at least one frame in between two of the plurality of frames based on the motion of the object, such that a time-resolution of the time-of-flight data stream is increased.

(19) The time-of-flight data generation method of anyone of (11) to (18), wherein the correlation is based on an optical flow integration.

(20) The time-of-flight data generation method of anyone of (11) to (19), wherein the correlation is based on a brightness change event count.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. Time-of-flight data generation circuitry, configured to:
acquire a time-of-flight data stream;
acquire a brightness change event data stream;
correlate the time-of-flight data stream with the brightness change event data stream in time with each other for generating at least one time-of-flight data frame; and
generate the at least one time-of-flight data frame.

2. The time-of-flight data generation circuitry of claim 1, wherein the time-of-flight data stream is indicative of a plurality of sub-frames.

3. The time-of-flight data generation circuitry of claim 2, further configured to:
determine a relative motion of an object within the plurality of sub-frames based on the brightness change event data stream.

4. The time-of-flight data generation circuitry of claim 3, further configured to:
determine a position of the object based on one sub-frame for compensating for the motion in the at least one time-of-flight data frame.

5. The time-of-flight data generation circuitry of claim 1, wherein the time-of-flight data stream is indicative of a plurality of frames.

6. The time-of-flight data generation circuitry of claim 5, further configured to:
determine a relative motion of an object in the plurality of frames based on the brightness change event data stream; and
determine a depth of a current frame based on a depth of a previous frame.

7. The time-of-flight data generation circuitry of claim 6, wherein the depth of the current frame is further determined based on a relative intensity change indicated by the brightness change event data stream.

8. The time-of-flight data generation circuitry of claim 5, further configured to:
determine a relative motion of an object in the plurality of frames based on the brightness change event data stream; and
generate at least one frame in between two of the plurality of frames based on the motion of the object, such that a time-resolution of the time-of-flight data stream is increased.

9. The time-of-flight data generation circuitry of claim 1, wherein the correlation is based on an optical flow integration.

10. The time-of-flight data generation circuitry of claim 1, wherein the correlation is based on a brightness change event count.

11. A time-of-flight data generation method, comprising:
acquiring a time-of-flight data stream;
acquiring a brightness change event data stream;
correlating the time-of-flight data stream with the brightness change event data stream in time with each other for generating at least one time-of-flight data frame; and
generating the at least one time-of-flight data frame.

12. The time-of-flight data generation method of claim 11, wherein the time-of-flight data stream is indicative of a plurality of sub-frames.

13. The time-of-flight data generation method of claim 12, further comprising:
determining a relative motion of an object within the plurality of sub-frames based on the brightness change event data stream.

14. The time-of-flight data generation method of claim 13, further comprising:
determining a position of the object based on one sub-frame for compensating for the motion in the at least one time-of-flight data frame.

15. The time-of-flight data generation method of claim 11, wherein the time-of-flight data stream is indicative of a plurality of frames.

16. The time-of-flight data generation method of claim 15, further comprising:
determining a relative motion of an object in the plurality of frames based on the brightness change event data stream; and
determining a depth of a current frame based on a depth of a previous frame.

17. The time-of-flight data generation method of claim 16, wherein the depth of the current frame is further determined based on a relative intensity change indicated by the brightness change event data stream.

18. The time-of-flight data generation method of claim 15, further comprising:
determining a relative motion of an object in the plurality of frames based on the brightness change event data stream; and
generating at least one frame in between two of the plurality of frames based on the motion of the object, such that a time-resolution of the time-of-flight data stream is increased.

19. The time-of-flight data generation method of claim 11, wherein the correlation is based on an optical flow integration.

20. The time-of-flight data generation method of claim 11, wherein the correlation is based on a brightness change event count.
